(19) United States
(12) Patent Application Publication
(10) Pub. No.: US 2025/0379346 A1
(43) Pub. Date: Dec. 11, 2025

(54) SEPARATOR COLLAR TO INSULATE CATHODE LEADS FOR AN ELECTROCHEMICAL CELL

(71) Applicant: Greatbatch Ltd., Clarence, NY (US)

(72) Inventors: Ho chul Yun, East Amherst, NY (US); Jordan Hartwig, East Aurora, NY (US); Joseph M. Lehnes, Williamsville, NY (US); Brian Hohl, Clarence, NY (US); Eric Herberger, East Aurora, NY (US)

(21) Appl. No.: 19/227,661

(22) Filed: Jun. 4, 2025

Related U.S. Application Data
(60) Provisional application No. 63/657,410, filed on Jun. 7, 2024.

(51) Int. Cl. H01M 50/593; H01M 50/533; H01M 50/586

(52) U.S. Cl. CPC H01M 50/593; H01M 50/533; H01M 50/586

(57) ABSTRACT

An electrode assembly for an electrochemical cell comprises a current collector having opposed faces extending to a peripheral edge connected to a tab. The current collector tab has a tab height measured from the frame peripheral edge to a tab distal edge. An electrode active material is contacted to the current collector to form an electrode. A separator envelope housing the electrode comprises a separator collar having a collar height measured from the frame peripheral edge to a collar distal edge. The collar height is less than the tab height so that a distal portion of the current collector tab is left uncovered by separator material. A distal edge of the separator collar resides adjacent to an imaginary tab fold line along which the tab is intended to be folded. The imaginary fold line is intermediate the frame peripheral edge and the tab distal edge.

### CROSS-REFERENCE TO RELATED APPLICATION

This claims priority from U.S. provisional patent application Ser. No. 63/657,410, filed on Jun. 7, 2024.

### BACKGROUND OF THE INVENTION

### 1. Field of the Invention

The present invention generally relates to the conversion of chemical energy to electrical energy. More particularly, this invention is directed to preventing lithium from bridging between positive and negative polarity portions of an electrochemical cell during discharge, particularly high-rate intermittent pulse discharge. A lithium bridge is referred to as a “lithium cluster” and, should it form, an internal loading mechanism that prematurely discharges the cell could result.

### 2. Prior Art

The mechanism controlling lithium deposition between positive and negative polarity portions of a case-negative primary lithium electrochemical cell, such as between the cathode tab and the negative polarity casing, is described in the publication by Takeuchi, E. S.; Thiebolt, W. C., J. Electrochem. Soc. 138, L44-L45 (1991). While this report specifically discusses measurements made on the lithium/silver vanadium oxide (Li/SVO) system, it also applies to other solid insertion type cathodes used in lithium cells where voltage decreases with discharge.

According to the investigators, lithium deposition is induced by a high-rate intermittent discharge of a Li/SVO cell. If it is too severe, the lithium deposition can form “clusters” that are large enough to bridge between the negative polarity casing and the positive polarity connection of a cathode tab extending outwardly from a cathode current collector to a terminal pin for the cell. This conductive bridge can then result in an internal loading mechanism that can prematurely discharge the cell.

The mechanism for lithium cluster formation is as follows: at equilibrium, the potential of a lithium anode is governed by the concentration of lithium ions in the electrolyte according to the Nernst equation. If the Lit ion concentration is increased over a limited portion of the anode surface, then the anode/electrolyte interface in this region is polarized anodically with respect to the anode/electrolyte interface over the remaining portion of the anode. Lithium ions are reduced in the region of higher concentration and lithium metal is oxidized over the remaining portion of the anode until the concentration gradient is relaxed. The concentration gradient is also relaxed by diffusion of lithium ions from the region of higher Lit ion concentration to lower concentration. However, as long as a concentration gradient exists, deposition of lithium is thermodynamically favored in the region of higher Lit ion concentration.

In a Li/SVO cell, the anode and cathode are placed in close proximity to each other across a thin separator. During an electrochemical reaction, Lit ions are discharged from the anode to intercalate into the cathode. In a high-rate pulse discharge, the Lit ion concentration gradient in the separator is dissipated as the Lit ions diffuse the short distance from the anode to the cathode where they intercalate into the pore structure of the cathode. However, electrolyte in contact with exposed electrode connection structures, for example, the cathode tab that extends outwardly from the cathode current collector and through a slit in the cathode separator envelope can be a site of higher Lit ion concentration. Lithium ions adjacent to this uncovered positive polarity structure have a longer distance to diffuse to the cathode than Lit ions discharged from the anode, through the separator and into the anode. Consequently, electrolyte at the uncovered cathode current collector tab maintains a higher concentration of Lit ions for a relatively longer period of time after a pulse discharge than electrolyte that wets the separator between the anode facing the cathode so that the tab is a surface from which a lithium cluster could bridge.

In a case-negative cell design, the lithium anode tab is typically welded to the inside of the casing. Therefore, if the connection of the anode tab to the casing is also wetted by electrolyte, the Lit ion concentration gradient extends from the cathode tab to the anode tab and the casing, and lithium cluster deposition is induced onto these surfaces by the Nernstian anodic potential shift derived from the higher Lit ion concentration in the electrolyte after a pulse discharge of the cell.

In that regard, the present invention is directed to an electrode assembly construction that connects multiple cathodes within an electrochemical cell. Each cathode has a cathode tab extending outwardly from a cathode current collector and through a slit in the cathode separator envelope so that the cathode tab can be readily connected to a terminal pin for the cell. It is not uncommon for the extending cathode tab to be left uncovered, which can then be a site for the formation of a lithium cluster to form and bridge over to a negative-polarity cell structure.

In that respect, there is a need for a separator collar that extends upwardly from opposed sheets of separator material that are bonded to each other around their overlapping peripheral edges to for an envelope for the cathode. The overlapping edges of the opposed collars extending from the opposed separator sheets are also bonded to each other. This serves to cover both major sides of the cathode tab and the opposed tab edges.

### SUMMARY OF THE INVENTION

Accordingly, the present invention is directed to the prevention of lithium clusters from bridging between negative and positive polarity structures of an electrochemical cell during discharge, particularly during a pulse discharge event. Covering all of the opposite polarity electrodes and their terminal connections helps accomplish this. Electrolyte that has a relatively higher Lit ion concentration in contact with an exposed positive- or a negative-polarity surface can create an anodically polarized region resulting in reduction of lithium ions on the exposed surface as the Lit ion concentration gradient is relaxed. Typically, a lithium-ion concentration gradient sufficient to cause lithium cluster formation is induced by the high rate, intermittent discharge of a Li/SVO cell.

The positive cell portions include: 1) the terminal pin that is electrically isolated from the casing by a non-conductive material such as glass or ceramic; 2) a cathode manifold that electrically connects the cathode electrode plates to the terminal pin; and 3) the cathode plates themselves, which are contacted to opposed sides of a cathode current collector and isolated from the anode by separator material. The negative cell portions include: 1) the casing; 2) the anode plates contacted to opposed sides of an anode current collector; and 3) anode tabs that connect the anode to the casing.

By encapsulating a positive polarity cathode tab extending outwardly from a cathode current collector, electrolyte flowing between the positive polarity cathode tab and the negative polarity casing that can potentially serve as surfaces for lithium bridging is greatly inhibited. In that respect, no opposite polarity surfaces are left exposed that could potentially serve as a site inside the casing where reduced lithium ions from the electrolyte as the lithium ion concentration gradient in the electrolyte relaxes can possibly form a lithium cluster.

These and other aspects of the present invention will become more apparent to those skilled in the art by reference to the following description and to the appended drawings.

### BRIEF DESCRIPTION OF THE DRAWINGS

FIG. 1 is a perspective view of an exemplary electrochemical cell 10 according to the present invention.

FIG. 2 is a cross-sectional view illustrating the internal construction of the electrochemical cell 10 shown in FIG. 1.

FIG. 3 is an elevational view of an embodiment of a single screen current collector for use in the electrochemical cell 10 shown in FIG. 1.

FIG. 3A is an elevational view of the single screen current collector shown in FIG. 3 built into a cathode contained in a separator envelope 46B having an upwardly extending collar 46B′ that covers a major portion of the cathode current collector tab 50A.

FIG. 4 is a plan view of a bi-screen current collector 56 that is useful with the present electrochemical cell 10.

FIG. 4A is a perspective view of the bi-screen current collector 56 shown in FIG. 4 but with the opposed cathode plates housed in respective separator envelopes 66, 68.

FIG. 4B is an enlarged view of the indicated section in FIG. 4A.

FIG. 5A is a perspective view of the opposed cathode plates shown in FIGS. 4A and 4B after having been folded at bridge 62 to form a folded cathode assembly.

FIG. 5B is an enlarged view of the indicated section in FIG. 5A.

FIG. 6 is a perspective view of an elongate anode 70 after having been folded into a serpentine shape.

FIG. 7 is a perspective view showing that after the bridge 62 of the bi-screen current collector 56 illustrated in FIGS. 4, 4A, 4B is folded along opposed fold lines 64A, 64B to form the folded cathode assembly illustrated in FIGS. 5A and 5B, four of the folded cathode assemblies are interleaved into adjacent slots of the serpentine anode 70 shown in FIG. 6.

FIG. 8 is a perspective view illustrating a manifold 78 connecting the four folded cathode assemblies shown in FIG. 7 together.

FIG. 9 is an open cross-sectional elevated view illustrating a lower insulator member resting on an edge of the folded cathode assemblies interleaved into adjacent slots of the serpentine anode 70 shown in FIG. 6.

FIG. 10 is an isometric view showing the lid 16 and an upper insulator member.

FIG. 11 is a cross-sectional elevated view showing the lower and upper insulating members illustrated in FIGS. 9 and 10 mated together to form an insulator compartment housing conductive bridge 62A, 62B, 62C and 62D, which are respectively connected to opposed cathode plates.

### DETAILED DESCRIPTION OF THE PREFERRED EMBODIMENTS

A lithium cluster is the result of a higher Lit ion concentration in the electrolyte immediately adjacent to a conductive surface creating an anodically polarized region resulting in the reduction of lithium ions on the conductive surface as the concentration gradient relaxes. Typically, a lithium-ion concentration gradient is induced by the high rate, intermittent discharge of a cell of a lithium/solid cathode active chemistry, such as a lithium/silver vanadium oxide (Li/SVO) cell.

The term “pulse” is defined as a short burst of electrical current of significantly greater amplitude than that of a pre-pulse current or open circuit voltage immediately prior to the pulse. A pulse train consists of at least one pulse of electrical current. The pulse is designed to deliver energy, power or current. If the pulse train consists of more than one pulse, they are delivered in relatively short succession with or without open circuit rest between the pulses. An exemplary pulse train may consist of one to four 5- to 20-second pulses with about a 2 to 30 second rest, preferably about 15 second rest, between each pulse. A typically used range of current densities for lithium/solid cathode active cells powering an implantable medical device is about 19 mA/cm² to about 50 mA/cm², and more preferably about 18 mA/cm² to about 35 mA/cm². A 10-second pulse is generally suitable for medical implantable applications. However, a discharge pulse can be significantly shorter or longer depending on the specific cell design and chemistry and the associated medical device's energy requirements. Current densities are based on square centimeters of the cathode. In that respect, an electrochemical cell according to the present invention must have sufficient energy density and discharge capacity to be a suitable power source for an implantable medical device. Contemplated medical devices include implantable cardiac pacemakers, defibrillators, neurostimulators, drug pumps, ventricular assist devices, and the like.

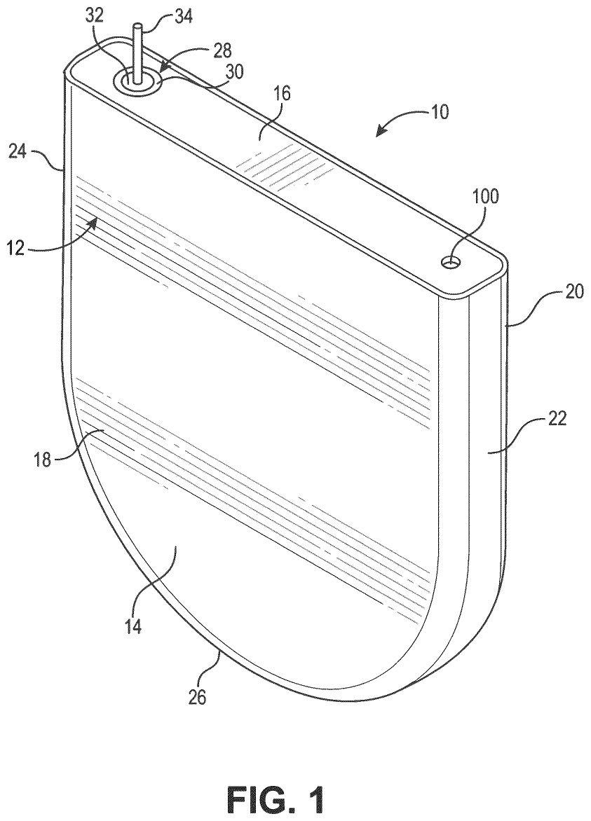

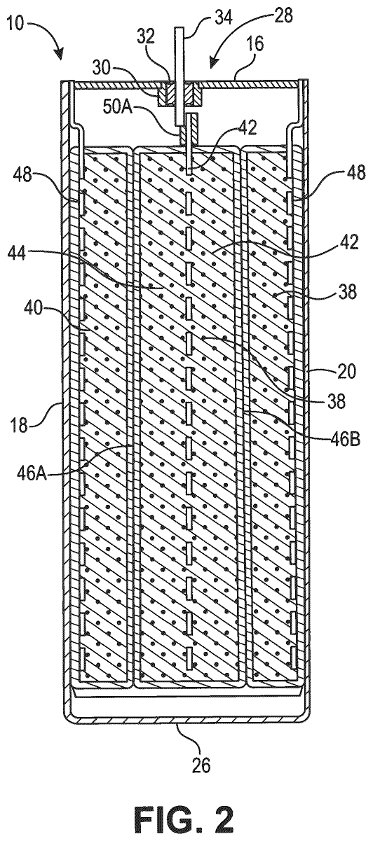

Referring now to the drawings, FIGS. 1 and 2 show an exemplary electrochemical cell 10 according to the present invention. The electrochemical cell 10 is preferably of a pulse dischargeable, non-rechargeable or primary chemistry having a case-negative design. However, the exemplary electrochemical cell 10 can also be of a rechargeable (secondary) chemistry and have a case-positive or a case-neutral design. The specific geometry and chemistry of the exemplary electrochemical cell 10 can be of a wide variety that meets the requirements of a particular primary and/or secondary cell application.

Looking first at FIG. 1, the exemplary electrochemical cell 10 comprises a metallic casing 12 having an open-ended container 14 closed by a lid 16. The open-ended container 14 has spaced apart first and second generally planar sidewalls 18 and 20 extending to and meeting with opposed end walls 22 and 24 and a bottom wall 26. The end walls and bottom wall can be curved to provide the casing having an oval cross-section, or they can be generally planar to provide the casing having a rectangular cross-section.

The metallic lid 16 for the casing 12 has an opening in which a glass-to-metal seal (GTMS) 28 is secured. The GTMS 28 comprises a ferrule 30 that supports an insulating glass 32. The insulating glass 32 hermetically seals between an inner surface of the ferrule 30 and a terminal pin 34. In that manner, the terminal pin 34 is electrically isolated from the rest of the casing 12 comprising the lid 16 sealed to the open end of the container 14. A suitable insulating glass 32 for the GTMS 28 is of a corrosion resistant type having up to about 50% by weight silicon such as CABAL 12, TA 23, FUSITE 425 or FUSITE 435.

Turning now to FIG. 2, the casing 12 for the exemplary electrochemical cell 10 houses an electrode assembly 36 comprising anode plates 38, 40 and cathode plates 42, 44 that are prevented from contacting each other by respective anode and cathode separator envelopes 46A and 46B. The anode plates 38, 40 are composed of an anode active material, preferably lithium, that is supported on an intermediate anode current collector 48. More specifically, the lithium anode active material is pressed onto the opposed major surfaces of the anode current collector 48. Although lithium is the preferred anode active material, lithium alloys such as lithium silver, lithium aluminum, lithium boron, lithium silver boron, carbon, and combinations thereof may also be used as anode active materials.

The cathode plates 42, 44 are composed of a cathode active material that is supported on the opposed major surfaces of an intermediate cathode current collector 50. Preferably, the cathode current collector 50 is of a screen or mesh construction with a plurality of openings or perforations 52 through which the cathode active material supported on the opposed major surfaces of the current collector can lock to itself. This helps to prevent the cathode active material from delaminating from or sloughing off of the current collector 50. Suitable cathode active materials include silver vanadium oxide, copper silver vanadium oxide, manganese dioxide, cobalt nickel, nickel oxide, copper oxide, copper sulfide, iron sulfide, iron disulfide, titanium disulfide, copper vanadium oxide, and mixtures thereof.

As previously described, the exemplary electrochemical cell 10 shown in FIGS. 1 and 2 is preferably of a case-negative design. Case-negative electrochemical cells are constructed with the anode plates 38, 40 being electrically connected to the casing 12 via the anode current collector 48 while the cathode plates 42, 44 are electrically connected to the electrically isolated terminal pin 34 of the GTMS 28 via a tab 50A extending outwardly from the cathode current collector 50. In a preferred embodiment, a proximal or device side end of the terminal pin 34 is connected the cathode current collector tab 50A, which extends upwardly from the perimeter frame 54 of the cathode current collector 50 and outwardly through a slit in the cathode separator envelope 46B, by a weld, preferably a weld made by a laser. A distal or device side end of the terminal pin 34 extends outside the casing 12 and is configured for subsequent connection to a load that will be powered by the cell 10.

Both the anode current collector 48 and the cathode current collector 50 are composed of an electrically conductive material. In a preferred embodiment, the anode current collector 48 and the cathode current collector 50 may be composed of a material comprising titanium, aluminum, stainless steel, nickel, tantalum, copper, platinum, gold, cobalt nickel alloys, highly alloyed ferritic stainless steel containing molybdenum and chromium, and nickel-, chromium- and molybdenum-containing alloys.

The terminal pin 34 may be composed of molybdenum, aluminum, tantalum, tungsten, and combinations thereof, the former being preferred. Alternatively, the terminal pin 34 may be composed of titanium, aluminum, stainless steel, tantalum, copper, platinum, gold, cobalt nickel alloys, highly alloyed ferritic stainless steel containing molybdenum and chromium, and nickel-, chromium- and molybdenum-containing alloys.

Alternatively, a case-positive cell design may be constructed by reversing these connections. In other words, the electrically isolated terminal pin 34 is connected to the electrode plates 38, 40 formed from anode active material, preferably lithium, via the current collector 48, and electrode plates 42, 22 formed of cathode active material are connected to the casing 12 via the current collector 50.

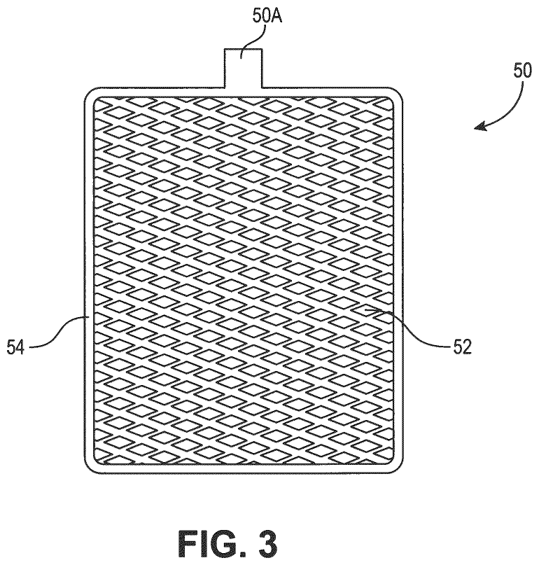

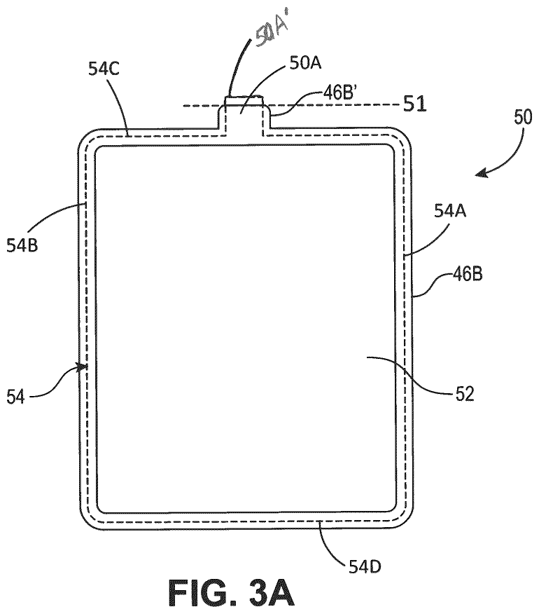

FIG. 3 illustrates in greater detail the current collector 50 that is used to construct the cathode plates 42, 44 for the case-negative cell design illustrated in FIG. 2. The current collector 50 has a screen portion 52 comprising a plurality of openings or perforations that is bounded by a co-planar unperforated frame 54. The frame 54 defines the perimeter or peripheral edge of the current collector 50 and surrounds the screen. The frame surrounding the openings 52 comprises opposed right and left frame edges 54A and 54B meeting an upper frame edge 54C opposite a lower frame edge 54D. The term “screen” is defined as a foil having a mesh or perforated grid. The screen is designed such that the cathode active material (not shown in FIG. 3) contacted to the opposed major faces of the screen portion 52 and the frame 54 locks to itself through the openings or perforations in the screen to form the cathode plates 42, 44 (FIG. 2).

In an alternate embodiment, the current collector 50 does not have the screen portion 52. Instead, the opposed major faces bounded by the frame 54 defining the perimeter or peripheral edge of the current collector are unperforated.

The cathode current collector tab 50A extending upwardly from the frame 54 of the cathode current collector 50 is preferably co-planar with the screen 52 and the frame 54. More preferably, the current collector tab 50A extends perpendicularly from the frame 54. It is noted that while the cathode current collector 50 including its screen 52 is illustrated having a rectangular shape, the current collector may have a multitude of shapes including but not limited to a square, a circle, a half circle, an oval, a triangle, or a generic curved shape.

FIG. 3A shows the cathode illustrated in FIG. 2 after having been housed inside the cathode separator envelope 46B. The cathode separator envelope 46B is comprised of two opposed sheets of separator material that extend outwardly beyond the opposed right and left frame edges 54A, 54B meeting the upper and lower frame edges 54C, 54D of the current collector 50 where they are heat sealed to each other around their respective peripheral edges. According to the present invention, the opposed separator sheets each have an upwardly extending collar 46B′ that covers a major portion of the cathode current collector tab 50A. Desirably, the separator collar 46B′ extends over the cathode current collector tab 50A, ending at a collar distal edge residing at or adjacent to an imaginary fold line 51. This provides the collar having a collar height measured from the frame peripheral edge to a collar distal edge.

The imaginary fold line 51 is spaced proximally from a distal or upper edge 50A′ of the tab so that the imaginary fold line 51 is intermediate the frame peripheral edge, for example, the upper frame edge 54C, and the tab distal edge 50A′. This provides the tab 50A having a tab height measured from the frame peripheral edge to the distal edge 50A′ of the tab peripheral edge so that the separator collar height is less than the tab height. In that manner, the imaginary fold line 51 is spaced distally from the upper frame edge 54C and proximally from the distal edge 50A′ of the tab so that the portion of the cathode current collector tab 50A extending distally from the fold line 51 is the only portion of the tab that is left uncovered by the collar 46B′. A suitable method for forming the separator envelope 46B including the collar 46B′ that covers the cathode current collector tab 50A is described in U.S. Pat. No. 6,508,901 to Miller et al., titled Thermo-Encapsulating System and Method, which is assigned to the assignee of the present invention and incorporated herein by reference.

Suitable materials for the opposed sheets forming the cathode separator envelope 46B including its upwardly extending collar 46B′ include a fabric woven from fluoropolymeric fibers including polyvinylidine fluoride, polyethylenetetrafluoroethylene, and polyethylenechlorotrifluoroethylene used either alone or laminated with a fluoropolymeric microporous film, non-woven glass, polypropylene, polyethylene, glass fiber materials, ceramics, polytetrafluoroethylene membrane commercially available under the designation ZITEX (Chemplast Inc.), polypropylene membrane commercially available under the designation CELGARD (Celanese Plastic Company, Inc.) and a membrane commercially available under the designation DEXIGLAS (C. H. Dexter, Div., Dexter Corp.).

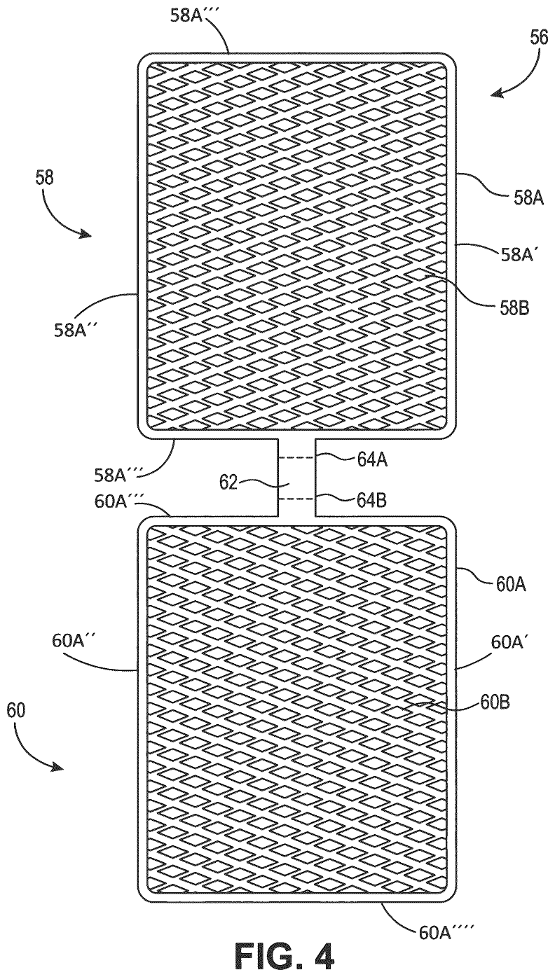

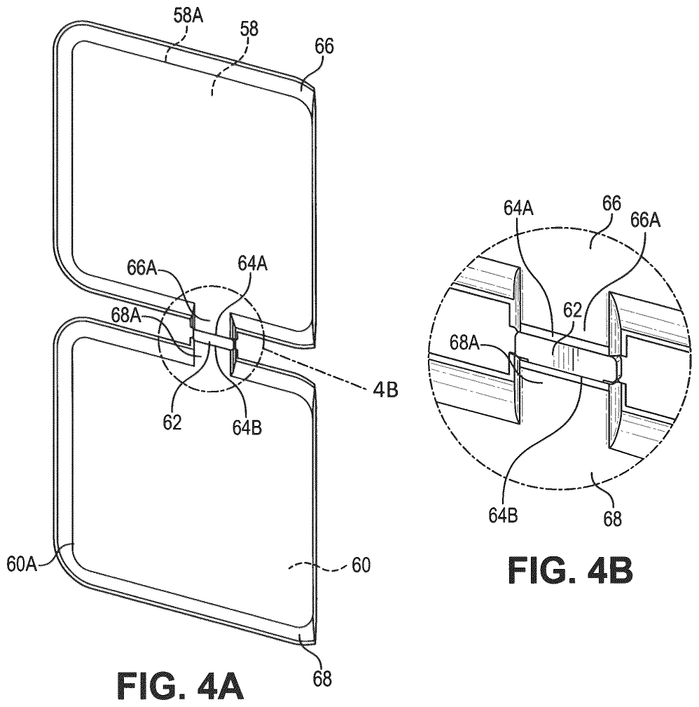

FIG. 4 illustrates an alternate embodiment of a bi-screen current collector 56 that is also useful with the present electrochemical cell 10. The bi-screen current collector 56 comprises two opposed current collectors 58 and 60 that are connected to each other by an intermediate bridge 62. Current collector 58 is comprised of a perimeter frame 58A surrounding a perforated screen 58B. The perimeter frame 58A comprises opposed right and left frame edges 58A′ and 58A″ meeting an upper frame edge 58A′″ opposite a lower frame edge 58A″″. Similarly, current collector 60 is comprised of a perimeter frame 60A surrounding a perforated screen 60B. The perimeter frame 60A comprises opposed right and left frame edges 60A′ and 60A″ meeting an upper frame edge 60A′″ opposite a lower frame edge 60A″″.

In an alternate embodiment, the bi-screen current collector 56 does not have the perforated screens 58B, 60B. Instead, the opposed major faces bounded by the frames 58A, 60A defining the perimeter or peripheral edges of the respective current collectors 58, 60 are unperforated.

The current collector bridge 62 connects between the frames 58A, 60A surrounding the respective screens 58B, 60B. That way, when the bridge 62 for the bi-screen current collector 56 is bent along fold lines 64A and 64B, the opposed current collectors 58, 60 supporting cathode active material on the opposed major surfaces of their respective frames/screens 58A/58B, 60A/60B face each other and are perpendicular to the bridge.

FIGS. 4A and 4B illustrate the cathode plates 42, 44 (FIG. 2) comprising cathode active material contacted to the opposed major sides of the cathode current collectors 58 and 60 comprising the current collector frames 58A, 60A surrounding the respective screens 58B, 60B. In this embodiment, the cathode active material supported by the current collectors 58 and 60 are housed inside respective separator envelopes 66 and 68. The separator envelopes 66 and 68 are comprised of two opposed sheets of separator material that have been heat sealed to each other around their respective peripheral edges. That is in a similar manner as previously described regarding the cathode separator envelope 46B shown in FIGS. 2 and 3A. This means that the edges of the opposed separator sheets enveloping the cathode active material supported on the current collector 58 that extend outwardly beyond the opposed right and left frame edges 58A′ and 58A″ meeting the upper and lower frame edges 58A′″, 58A″″ are sealed to each other. Similarly, the edges of the opposed separator sheets enveloping the cathode active material supported on the current collector 60 that extend outwardly beyond the opposed right and left frame edges 60A′ and 60A″ meeting the upper and lower frame edges 60A′″, 60A″″ of the current collector 60 are sealed to each other.

According to the present invention, the opposed separator sheets forming the envelopes 66 and 68 have respective collars 66A and 68A that extends upwardly beyond the upper frames edges 58A′″ and 60A′″ of the respective current collector frames 58A, 60A so that the collar 66A, 68A covers a major portion of the cathode current collector bridge 62. Desirably, the opposed separator collars 66A, 68A extend over the bridge 62, ending at or immediately adjacent to the respective fold lines 64A, 64B. This means that the portion of the bridge 62 intermediate the fold lines 64A, 64B is the only portion of the bridge that is left uncovered by the respective separator collars 66A and 68A.

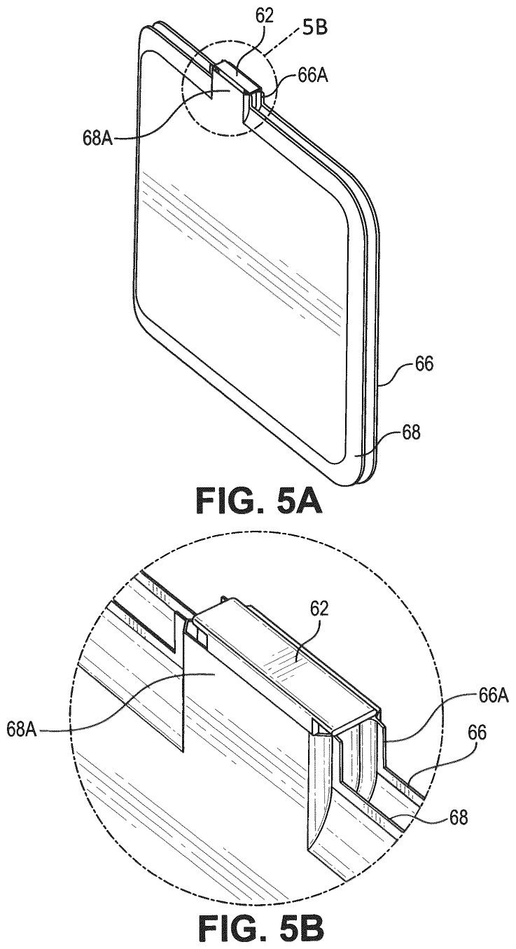

FIGS. 5A and 5B illustrate the opposed cathodes connected together by the bridge 62 after they have been folded toward each other at the respective fold lines 64A, 64B along the bridge 62. In that manner, the opposed separator collars 66A and 68A are shown extending along the bridge 62 but ending just short of or immediately adjacent to their respective fold lines 64A, 64B.

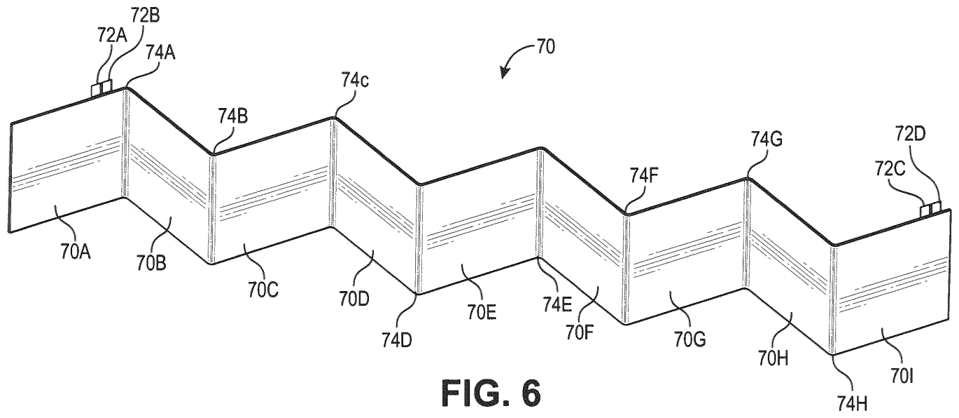

FIG. 6 illustrates an elongate anode 70 that is comprised of anode active material, preferably lithium, press-contacted to the opposed major faces of an anode current collector (not shown). The elongate anode 70 is then housed inside its own separator envelope, for example, one similar to the separator envelopes 46A shown in FIG. 2. Suitable separator materials are those that have already been described with respect to the cathode separator envelope 46B. The anode current collector has upstanding current collector tab pairs 72A, 72B and 72C, 72D which extend outwardly from the separator envelope.

The anode 70 is folded at spaced intervals along fold lines 74A, 74B, 74C, 74D, 74E, 74F, 74G and 74H. The series of spaced apart folds 74A to 74H are oriented in alternating directions to thereby form the anode 70 having a serpentine-like shape. In that manner, the serpentine-shaped anode is comprised of alternating plate-shaped sections 70A and 70B meeting at fold 74A to form slot 76A, plate-shaped sections 70B and 70C meeting at fold 74B to form slot 76B, plate-shaped sections 70C and 70D meeting at fold 74C to form slot 76C, plate-shaped sections 70D and 70E meeting at fold 74D to form slot 76D, plate-shaped sections 70E and 70F meeting at fold 74E to form slot 76E, plate-shaped sections 70F and 70G meeting at fold 74F to form slot 76F, plate-shaped sections 70G and 70H meeting at fold 74G to form slot 76G, and plate-shaped sections 70H and 70I meeting at fold 74H to form slot 76H.

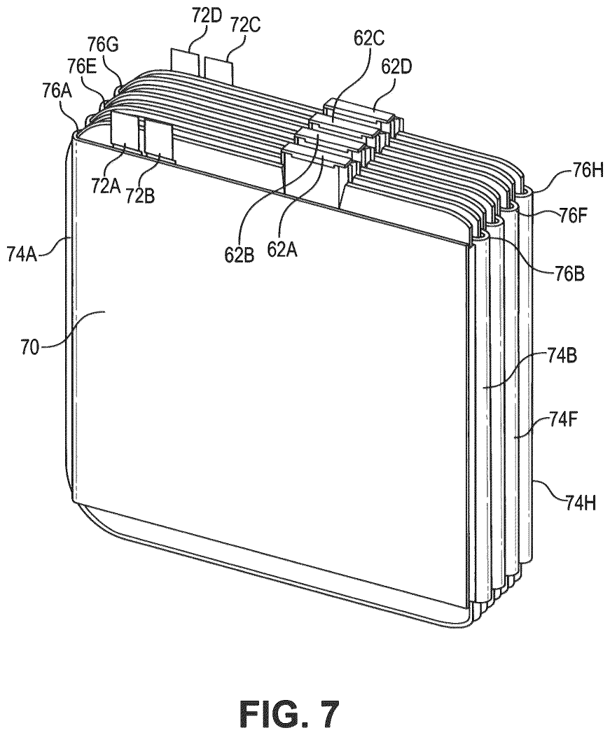

FIG. 7 shows that after the bridge 62 of the cathode assembly illustrated in FIGS. 4, 4A, 4B is folded along the opposed fold lines 64A, 64B to form the folded cathode assembly illustrated in FIGS. 5A and 5B, four of the folded cathode assemblies are interleaved into adjacent slots of the serpentine anode 70. In particular, opposed cathode plates connected together by a first conductive bridge 62A are received into adjacent anode slots 76A and 76B, opposed cathode plates connected together by a second conductive bridge 62B are received into adjacent anode slots 76C and 76D, opposed cathode plates connected together by a third conductive bridge 62C are received into adjacent anode slots 76E and 76F and opposed cathode plates connected together by a fourth conductive bridge 62D are received into adjacent anode slots 76G and 76H.

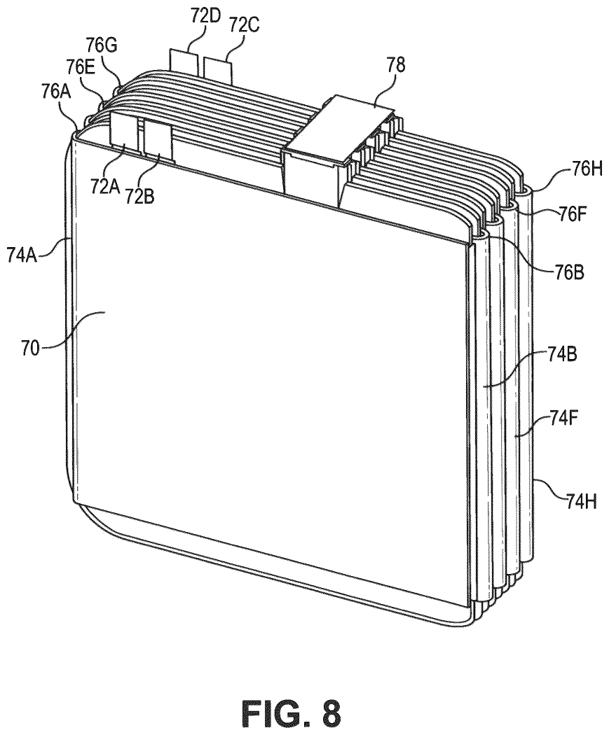

FIG. 8 shows that a manifold 78 of an electrically conductive metal is laid on top of the side-by-side bridges 62A. 62B, 62C and 62D. The cathode manifold 78 is welded to the bridges to electrically connect the cathodes together.

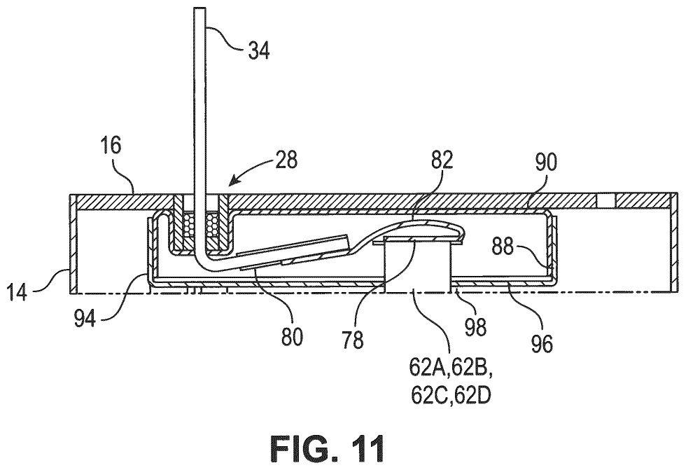

As previously described, the cathode terminal pin 34 extends through the glass-to-metal seal 28, where it is electrically isolated from the lid 16 closing the container 14. The terminal pin 34 has a proximal end with a curved region (FIG. 11) that is received in a coupling member 80. During final cell assembly, the coupling member 80 is secured to an intermediate conductive ribbon 82 that is electrically connected to the cathode manifold 78.

Referring back to FIG. 3A, an electrode assembly for the exemplary electrochemical cell 10 has a plurality of cathodes, each contained in a separator envelope 46B with their cathode current collector tab 50A covered by an upwardly extending collar 46B′ that covers a major portion of the tab up to the tab fold line 51. As described in U.S. Pat. No. 10,170,744 to Dai, which is assigned to the assignee of the present invention and incorporated herein by reference, a plurality of cathode connection tabs 50A are folded over each other to form a compact electrode junction that is welded together such as by a laser, resistance, or ultrasonic weld joint. The cathode junction is connected to the proximal end of the ribbon 82 opposite the coupling member 80. The proximal end of the terminal pin 34 is received in the coupling member 80 and the coupling member is connected to the distal end of the ribbon 82. These connections establish electrical continuity from the plurality of folded cathode tabs 50A to the coupling member 80 and then to the terminal pin 34, which is electrically isolated from the negative polarity casing 12 comprising the container 14 closed by the lid 16 by the GTMS 28.

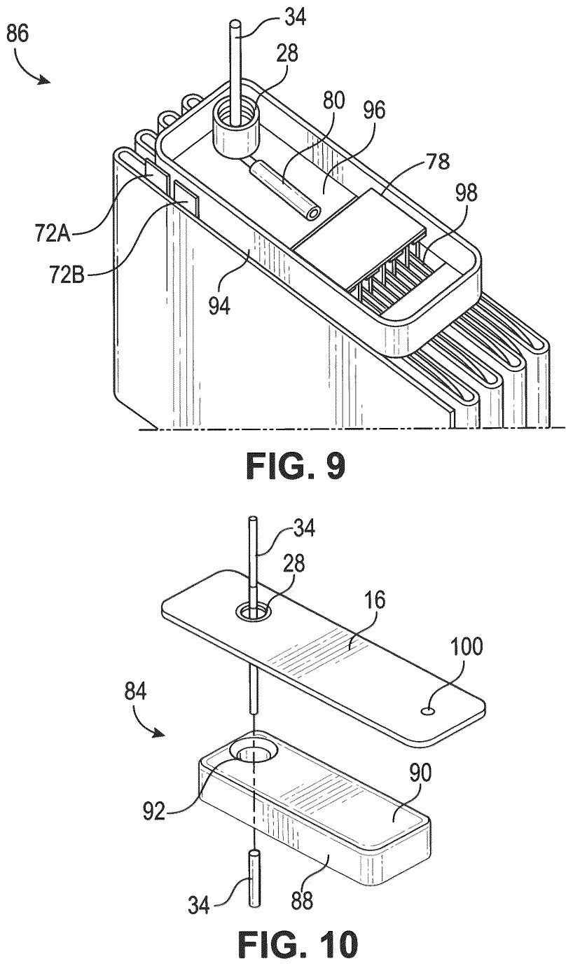

As shown in FIGS. 9 to 11, the exemplary electrochemical cell 10 illustrated in FIG. 1 also includes an insulator compartment residing between the electrode assembly 36 and the casing 12 to house the cathode manifold 78 and coupling member 80 conductively connected to the terminal pin 34. The insulator compartment comprises a first or upper insulator member 84 mated to a second or lower insulator member 86. The upper insulator member 84 has a first or upper surrounding sidewall 88 meeting a first or upper major face wall 90. The upper major face wall 90 is disposed adjacent to an inner surface of the lid 16 with the upper surrounding sidewall 88 extending towards the electrode assembly 36. The upper major face wall 90 has a first or upper opening 92 for the terminal pin 34.

The second or lower insulator member 86 has a second or lower surrounding sidewall 94 meeting a second or lower major face wall 96, which is disposed adjacent to the perimeter edge of the electrode assembly 36 with the lower surrounding sidewall 94 extending toward the lid 16. The lower major face wall 96 has a second or lower opening 98 for the first, second, third and fourth conductive bridges 62A, 62b, 62C and 62D.

The insulator compartment is constructed by mating an outer edge of one of the upper and lower surrounding sidewalls 88, 94 facing the other of the upper and lower major face walls 90, 96 such that at least a portion of the lower surrounding sidewall 94 overlaps and is in direct contact with at least a portion of the upper surrounding sidewall 88. This engaged configuration defines an overlapping compression fit with an end surface of the upper surrounding sidewall 88 of the upper insulator member 84 substantially abutting the lower major face wall 96 of the lower insulator member 86. In other words, the surface area of the lower major face wall 96 is greater than the surface area of the upper major face wall 90 to form the insulator compartment with the lower surrounding sidewall 94 of the lower insulator member 86 overlapping the upper surrounding sidewall 88 of the upper insulator member 84.

The thusly constructed electrode assembly 36 including the insulator compartment is then inserted into the open-ended casing container 14 shown in FIG. 1. The upstanding anode current collector tab pairs 72A, 72B and 72C, 72D are connected to an internal surface of opposed sidewalls forming the casing container, for example, sidewalls 18 and 20. The anode current collector tabs are provided in pairs as a redundant feature that ensures good electrical connections of the anode to the casing 12 for the case-negative cell design.

With the proximal end of the terminal pin 34 secured in the coupling member 80 and the proximal end of the conductive ribbon 82 connected to the cathode manifold 78, the distal end of the ribbon 82 is connected to the coupling member 80. These connections establish electrical continuity from the various cathode plate pairs to the cathode manifold 78 connected to the coupling member 80 and then to the terminal pin 34, which is electrically isolated from the negative polarity casing 12 comprising the container 14 closed by the lid 16 by the GTMS 28. In that manner, the terminal pin 34 is the positive terminal for the electrochemical cell 10.

The lid 16 is then fitted to the open end of the container 14 and secured in position by a weld, preferably made using a laser. This is followed by activating the electrode assembly 36 with an electrolyte that is filled into the casing 12 through a fill port 100 in the lid 16. Finally, the fill port 100 is hermetically sealed by close welding a fill plug into the port 100 to complete construction of the electrochemical cell 10. If desired, terminations can also be connected to the casing lid 16 to aid in connecting the cell 10 to a load.

As previously discussed, a preferred cathode active material is selected from the group consisting of silver vanadium oxide, copper silver vanadium oxide, manganese dioxide, cobalt nickel, nickel oxide, copper oxide, copper sulfide, iron sulfide, iron disulfide, titanium disulfide, copper vanadium oxide, and mixtures thereof. However, before fabrication into an electrode for incorporation into an electrochemical cell, the cathode active material is mixed with a binder material such as a powdered fluoro-polymer, more preferably powdered polytetrafluoroethylene or powdered polyvinylidene fluoride present at about 1 to about 5 weight percent of the cathode mixture. Further, up to about 10 weight percent of a conductive diluent is preferably added to the cathode mixture to improve conductivity. Suitable materials for this purpose include acetylene black, carbon black and/or graphite or a metallic powder such as powdered nickel, aluminum, titanium, and stainless steel. The preferred cathode active mixture thus includes a powdered fluoro-polymer binder present at about 3 weight percent, a conductive diluent present at about 3 weight percent and about 94 weight percent of the cathode active material.

The cathode plates 42, 44 may be prepared by rolling, spreading, or pressing the cathode active mixture such that it is generally in the form of a sheet or foil. The cathode electrode mixture is preferably pressed onto the surface of the cathode current collectors 50 (FIG. 3) and 58, 60 (FIG. 4).

The exemplary electrochemical cell 10 includes a nonaqueous, ionically conductive electrolyte having an inorganic, ionically conductive salt dissolved in a nonaqueous solvent and, more preferably, a lithium salt dissolved in a mixture of a low viscosity solvent and a high permittivity solvent. The salt serves as the vehicle for migration of the anode ions to intercalate or react with the cathode active material and suitable salts include LiPF₆, LiBF₄, LiAsF₆, LiSbF₆, LiClO₄, LiO₂, LiAlCl₄, LiGaCl₄, LiC(SO₂CF₃)₃, LiN(SO₂CF₃)₂, LiSCN, LiO₃SCF₃, LiC₆F₅SO₃, LiO₂CCF₃, LiSO₆F, LiB(C₆H₅)₄, LiCF₃SO₃, and mixtures thereof.

Suitable low viscosity solvents include esters, linear and cyclic ethers and dialkyl carbonates such as tetrahydrofuran (THF), methyl acetate (MA), diglyme, trigylme, tetragylme, dimethyl carbonate (DMC), 1,2-dimethoxyethane (DME), 1,2-diethoxyethane (DEE), 1-ethoxy, 2-methoxyethane (EME), ethyl methyl carbonate, methyl propyl carbonate, ethyl propyl carbonate, diethyl carbonate, dipropyl carbonate, and mixtures thereof. High permittivity solvents include cyclic carbonates, cyclic esters, and cyclic amides such as propylene carbonate (PC), ethylene carbonate (EC), butylene carbonate, acetonitrile, dimethyl sulfoxide, dimethyl, formamide, dimethyl acetamide, γ-valerolactone, γ-butyrolactone (GBL), N-methyl-pyrrolidinone (NMP), and mixtures thereof.

By way of example, in an illustrative case-negative primary cell, lithium is the preferred active material for the anode plates 38, 40, and silver vanadium oxide, as described in U.S. Pat. Nos. 4,310,609 and 4,391,729 to Liang et al., both of which are assigned to the assignee of the present invention, is the preferred active material for the cathode plates 42, 44. The preferred electrolyte for this electrochemical couple is 0.8 M to 1.5 M LiAsF₆ or LiPF₆ dissolved in a 50:50 mixture, by volume, of PC as the preferred high permittivity solvent and DME as the preferred low viscosity solvent.

Now, it is therefore apparent that the present invention has many features among which are reduced manufacturing cost and construction complexity. While embodiments of the present invention have been described in detail, it is for the purpose of illustration, not limitation.

What is claimed is:

1. An electrode for an electrochemical cell, the electrode comprising:
a) an electrically conductive current collector comprising:
i) opposed first and second major faces extending to a frame defining a peripheral edge; and
ii) a current collector tab extending outwardly from the frame peripheral edge, wherein the tab comprises opposed first and second tab faces extending to a tab peripheral edge, and wherein the tab has a tab height measured from the frame peripheral edge to a distal edge of the tab peripheral edge; and
b) an electrode active material contacted to the opposed first and second major faces of the current collector, wherein the electrode active material extends outwardly beyond the frame peripheral edge to thereby provide an electrode having an electrode peripheral edge;
c) a separator envelope housing the electrode, the separator envelope comprising:
i) opposed first and second separator sheets covering the electrode active material contacted to the opposed first and second major faces of the current collector, the first and second separator sheets extending outwardly beyond the electrode peripheral edge where they are secured to each other to thereby house the electrode; and
ii) a separator collar comprising first and second collar portions extending from the respective first and second separator sheets, wherein the first and second collar portions extend over the respective first and second tab faces and outwardly beyond the tab peripheral edge where the first and second collar portions are secured to each other.

2. The electrode of claim 1, wherein the first and second collar portions have a collar height measured from the frame peripheral edge to a collar distal edge, the collar height being less than the tab height.

3. The electrode of claim 1, wherein the current collector frame surrounds a perforated portion comprising a plurality of openings extending to the opposed first and second major faces, and wherein the electrode active material contacted to the opposed first and second major faces locks to itself through the plurality of perforations comprising the perforated portion of the current collector.

4. The electrode of claim 1, wherein the current collector tab has an imaginary tab fold line along which the tab is intended to be folded, the imaginary fold line being intermediate the frame peripheral edge and the tab distal edge.

5. The electrode of claim 1, wherein the frame peripheral edge comprises at least opposed right and left frame edges meeting an upper frame edge, and wherein the tab peripheral edge comprises at least opposed tab right and left tab edges meeting the tab distal edge.

6. The electrode of claim 1, wherein the first and second collar portions are continuous with the respective first and second separator sheets.

7. The electrode of claim 1, configured as a cathode for incorporation into an electrochemical cell of either a primary or a secondary chemistry.

8. An electrode for an electrochemical cell, the electrode comprising:
a) an electrically conductive bi-screen current collector comprising:
i) a first current collector comprising opposed first and second major faces extending to a first frame defining a first peripheral edge;
ii) a second current collector comprising opposed third and fourth major faces extending to a second frame defining a second peripheral edge; and
iii) an intermediate bridge having a bridge length measured from the first peripheral edge to the second peripheral edge of the respective first and second current collector frames; and
b) a first electrode active material contacted to the opposed first and second major faces of the first current collector, wherein the first electrode active material extends outwardly beyond the first frame peripheral edge to thereby provide a first electrode having a first electrode peripheral edge;
c) a second electrode active material contacted to the opposed third and fourth major faces of the second current collector, wherein the second electrode active material extends outwardly beyond the second frame peripheral edge to thereby provide a second electrode having a second electrode peripheral edge;
c) a first separator envelope housing the first electrode, the first separator envelope comprising:
i) opposed first and second major separator sheets covering the first electrode active material contacted to the opposed first and second major faces of the first current collector, the first and second separator sheets extending outwardly beyond the first electrode peripheral edge where they are secured to each other to thereby house the first electrode; and
ii) a first separator collar comprising first and second collar portions extending from the respective first and second major separator sheets, wherein the first and second collar portions extend over a first portion of the bridge and outwardly beyond the bridge peripheral edge where the first and second collar portions are secured to each other, and wherein the first and second collar portions have a first collar height measured from the first frame peripheral edge part-way along the bridge length to a first collar distal edge that is spaced from the second current collector; and
d) a second separator envelope housing the second electrode, the second separator envelope comprising:
i) opposed third and fourth major separator sheets covering the second electrode active material contacted to the opposed third and fourth faces of the second current collector, the third and fourth separator sheets extending outwardly beyond the second electrode peripheral edge where they are secured to each other to thereby house the second electrode; and
ii) a second separator collar comprising third and fourth collar portions extending from the respective third and fourth major separator sheets, wherein the third and fourth collar portions extend over a second portion of the bridge and outwardly beyond the bridge peripheral edge where the third and fourth collar portions are secured to each other, and wherein the third and fourth collar portions have a second collar height measured from the second frame peripheral edge part-way along the bridge length to a second collar distal edge that is spaced from the first collar distal edge.

9. The electrode of claim 8, wherein the first frame surrounds a plurality of first openings extending to the opposed first and second major faces and the second frame surrounds a plurality of second openings extending to the opposed third and fourth major faces, and wherein the first electrode active material locks to itself through the plurality of first openings and the second electrode active material locks to itself through the plurality of second openings.

10. The electrode of claim 8, wherein the first collar distal edge extends adjacent to an imaginary first fold line along which the bridge is intended to be folded, and the second collar distal edge extends adjacent to an imaginary second fold line along which the bridge is intended to be folded, and wherein an uncovered portion of the bridge is intermediate the first and second collar distal edges.

11. The electrode of claim 10, wherein the bridge is folded at the respective first and second imaginary fold lies so that the first and second electrodes are aligned substantially parallel to but spaced from each other.

12. The electrode of claim 10, wherein, with the bridge folded along the first and second fold lines, the first and second electrodes are spaced from each other by a length of the uncovered portion of the bridge intermediate the first and second collar distal edges.

13. The electrode of claim 8, wherein the electrically conductive bi-screen current collector is selected from the group of aluminum, nickel, copper, stainless steel, tantalum, cobalt and titanium, and alloys thereof.

14. The electrode of claim 8, wherein the first and second electrode active materials are individually selected from silver vanadium oxide, copper silver vanadium oxide, manganese dioxide, cobalt nickel, nickel oxide, copper oxide, copper sulfide, iron sulfide, iron disulfide, titanium disulfide, copper vanadium oxide, and mixtures thereof.

15. An electrochemical cell, comprising:
a) a casing comprising an open-ended metallic container closed by a metallic lid;
b) an electrode assembly housed inside the casing, the electrode assembly comprising:
i) a lithium anode connected to the casing serving as a negative terminal for the cell;
ii) a cathode comprising:
A) a first current collector comprising opposed first and second major faces extending to a first frame defining a first peripheral edge;
B) a first cathode active material contacted to the opposed first and second major faces of the first current collector, wherein the first cathode active material extends outwardly beyond the first frame peripheral edge to thereby provide a first cathode having a first cathode peripheral edge;
C) a second current collector comprising opposed third and fourth major faces extending to a second frame defining a second peripheral edge;
D) a second cathode active material contacted to the opposed third and fourth major faces of the second current collector, wherein the second cathode active material extends outwardly beyond the second frame peripheral edge to thereby provide a second cathode having a second cathode peripheral edge;
E) an intermediate bridge having a bridge length measured from the first peripheral edge to the second peripheral edge of the first and second frames of the respective first and second current collectors of the first and second cathodes; and
c) a first separator envelope housing the first cathode, the first separator envelope comprising:
i) opposed first and second major separator sheets covering the first cathode active material contacted to the opposed first and second major faces of the first current collector, the first and second separator sheets extending outwardly beyond the first cathode peripheral edge where they are secured to each other to thereby house the first cathode; and
ii) a first separator collar comprising first and second collar portions extending from the respective first and second major separator sheets, wherein the first and second collar portions extend over a first portion of the bridge and outwardly beyond the bridge peripheral edge where the first and second collar portions are secured to each other, and wherein the first and second collar portions have a first collar height measured from the first frame peripheral edge part-way along the bridge length to a first collar distal edge that is spaced from the second current collector; and
d) a second separator envelope housing the second cathode, the second separator envelope comprising:
i) opposed third and fourth major separator sheets covering the second cathode active material contacted to the opposed third and fourth faces of the second current collector, the third and fourth separator sheets extending outwardly beyond the second cathode peripheral edge where they are secured to each other to thereby house the second cathode; and
ii) a second separator collar comprising third and fourth collar portions extending from the respective third and fourth major separator sheets, wherein the third and fourth collar portions extend over a second portion of the bridge and outwardly beyond the bridge peripheral edge where the third and fourth collar portions are secured to each other, and wherein the third and fourth collar portions have a second collar height measured from the second frame peripheral edge part-way along the bridge length to a second collar distal edge that is spaced from the first collar distal edge,
iii) wherein the first collar distal edge extends adjacent to an imaginary first fold line along which the bridge is folded, and the second collar distal edge extends adjacent to an imaginary second fold line along which the bridge is folded so that the first and second cathodes are aligned substantially parallel to but spaced from each other, and wherein an uncovered portion of the bridge is intermediate the first and second collar distal edges; and
e) wherein the lithium anode has an elongated shape that is folded at at least a first anode fold line and a second anode fold line to thereby form a first anode slot and a second anode slot, and wherein the first cathode is interleaved into the first anode slot and the second cathode is interleaved into the second cathode slot to form the electrode assembly;
f) a glass-to-metal seal (GTMS) supported in the lid, the GTMS comprising a terminal pin that is electrically isolate from the casing by an insulator glass,
g) wherein the intermediate bridge connected to the first and second current collectors of the first and second cathodes interleaved into the first and second anode slots is connected to the terminal pin serving as positive terminal for the cell.

16. The electrochemical cell of claim 15, wherein the first frame surrounds a plurality of first openings extending to the opposed first and second major faces and the second frame surrounds a plurality of second openings extending to the opposed third and fourth major faces, and wherein the first cathode active material locks to itself through the plurality of first openings and the second cathode active material locks to itself through the plurality of second openings.

17. The electrochemical cell of claim 15, wherein the first and second cathode active materials are individually selected from silver vanadium oxide, copper silver vanadium oxide, manganese dioxide, cobalt nickel, nickel oxide, copper oxide, copper sulfide, iron sulfide, iron disulfide, titanium disulfide, copper vanadium oxide, and mixtures thereof.
